(19) United States
(12) Patent Application Publication
(10) Pub. No.: US 2003/0231257 A1
(43) Pub. Date: Dec. 18, 2003

(54) Display device and method for using the same

(75) Inventors: Kazunori Ochiai, Yamanashi (JP); Tetsuro Nagakubo, Yamanashi (JP)

Correspondence Address: SUGHRUE MION, PLLC, 2100 Pennsylvania Avenue, NW, Washington, DC, 20037-3213, US

(73) Assignees: PIONEER CORPORATION; PIONEER DISPLAY PRODUCTS CORPORATION

(21) Appl. No.: 10/411,351

(22) Filed: Apr. 11, 2003

(30) Foreign Application Priority Data
Apr. 11, 2002 (JP) P2002-109385

(51) Int. Cl. H04N 3/24; H04N 5/08; H04N 5/21; H04N 5/217

(52) U.S. Cl. 348/470; 348/607; 348/634; 348/533

(57) ABSTRACT

A display device that is capable of displaying either one of a video signal whose aspect ratio coincides with that of a display screen and a video signal whose aspect ratio differs includes a boundary-position detector 5 for detecting a boundary position between a signal of a picture portion of the video signal whose aspect ratio differs and a signal of a non-picture portion on the basis of the video signal and a synchronizing signal which are inputted to the boundary-position detector 5, a masking-control-signal generator 15 for generating a masking control signal for masking the non-picture portion and an end portion of the picture, and a masking section 6 for replacing the signals of the non-picture portion and the end of the picture portion with a predetermined substitute video.

### CROSS REFERENCE OF RELATED APPLICATION

This application is based on and claims priority under 35 U.S.C. §119 with respect to Japanese Patent Application No. 2002-109385 filed on Apr. 11, 2002, the entire content of which is incorporated herein by reference.

### BACKGROUND OF THE INVENTION

The present disclosure relates to the subject matter contained in Japanese Patent Application No. P2002-109385 filed Apr. 11, 2002, which is incorporated herein by reference in its entirety.

The present invention relates to a display device, and more particularly to a display device such as a wide screen television that has a display screen whose aspect ratio is 16:9 and which is adapted to mask both ends of a picture in a case where a video signal having an aspect ratio of 4:3 is displayed.

Conventionally, in a display device such as a wide screen television for displaying a video signal having an aspect ratio of 16:9, such as a high definition television (HDTV), i.e., a display device having a display screen whose aspect ratio is 16:9, in a case where a video signal having an aspect ratio of 4:3 is displayed, it has been the conventional practice to transmit this video signal having the 4:3 aspect ratio as it is to the display device and display it on the display screen having the 16:9 aspect ratio, and to display blank portions of a black color at both end portions of this picture.

It should be noted that these blank portions of the black color are conventionally generated by a masking signal which is formed on the basis of a received signal of television broadcasting or a reproduced video signal from a video circuit or the like.

In addition, as is also shown in JP-A-2000-175122, a measure has also been conventionally devised to convert the aspect ratio of the video signal to the same aspect ratio as that of the display screen by an aspect-ratio controlling circuit so as to prevent burning which occurs in the vicinity of a boundary between a picture portion having the 4:3 aspect ratio and each blank portion.

With the conventional display device such as a wide screen television having a display screen whose aspect ratio is 16:9, blank portions of a black color or the like are displayed at both ends of the picture, as described above. However, since the masking signal is formed on the basis of a received signal of television broadcasting or a reproduced video signal from a video circuit or the like, there has been a problem in that the disturbance of the picture occurs in the vicinity of a boundary between an actual picture and each of these blank portions.

FIG. 7 is an explanatory diagram explaining the disturbance of a picture which occurs in a case where the video signal having the 4:3 aspect ratio is displayed in a conventional display device having the display screen whose aspect ratio is 16:9.

Further, FIG. 7 shows a state in which disturbed portions 93a and 93b of a picture have each occurred in the vicinity of a boundary between a picture portion 92 having the 4:3 aspect ratio and each blank portion 94a, 94b within a display screen 91 having the 16:9 aspect ratio.

Namely, with the conventional display device such as a wide screen television having the 16:9 aspect ratio, the masking signal for generating the blank portions 94a and 94b is formed on the basis of a synchronizing signal of a received signal of television broadcasting or a reproduced video signal from a video circuit or the like. However, since these signals include jitter components, each of the disturbed portions 93a and 93b of the picture occurs in the vicinity of the boundary between the picture portion 92 having the 4:3 aspect ratio and each blank portion 94a, 94b, as shown in FIG. 7.

It should be noted in JP-A-2000-175122, burning does not occur since the boundary between the picture portion having the 4:3 aspect ratio and each blank portion in the conventional case disappears. However, since the aspect ratio of the picture is converted, there is a drawback in that the work (content) becomes different from the original picture in terms of the impression and texture.

### SUMMARY OF THE INVENTION

The invention has been devised in view of the above circumstances, and its object is to provide a display device which has a display screen whose aspect ratio is 16:9 and which is capable of displaying a high-quality picture by concealing the disturbance of the picture in the vicinity of a boundary between a picture portion of the video signal having the 4:3 aspect ratio and each blank portion on the display screen.

Another object of the invention is to provide a display device which has a display screen whose aspect ratio is 16:9 and which is capable of suppressing burning in the vicinity of a boundary between a picture portion of the video signal having the 4:3 aspect ratio and each blank portion on the display screen.

According to first aspect of the invention, there is provided a display device which is capable of displaying either one of a video signal whose aspect ratio coincides with that of a display screen and a video signal whose aspect ratio differs, the display device including a boundary-position detector for detecting a boundary position between a signal of a picture portion of the video signal whose aspect ratio differs and a signal of a non-picture portion on the basis of the video signal and a synchronizing signal which are inputted to the boundary-position detector, a masking-control-signal generator for generating a masking control signal for masking the non-picture portion and an end portion of the picture portion on the basis of the boundary position detected, and a masking section for replacing the signals of the non-picture portion and the end of the picture portion with a predetermined substitute video signal on the basis of the masking control signal.

Accordingly, in the display device having the display screen with a predetermined aspect ratio, when the video signal whose aspect ratio differs from this predetermined aspect ratio is displayed, a disturbed portion of the picture is not produced in the vicinity of a boundary between the picture portion of the video signal and the blank portion on the display screen.

In addition, according to second aspect of the invention, there is provided the boundary-position detector detects the boundary position by detecting a change of luminance of the inputted video signal.

Accordingly, the detection of the boundary between the picture portion and the blank portion can be realized by a simple circuit configuration.

In addition, according to third aspect of the invention, the. display device in accordance with the invention is characterized in that the aspect ratio of the display screen is 16:9, and the aspect ratio of the video signal whose aspect ratio differs is 4:3.

Accordingly, in the display device having the display screen whose aspect ratio is 16:9, such as a high definition television, a disturbed portion of the picture is not produced in the vicinity of the boundary between the picture portion and the blank portion when the conventional video signal having the 4:3 aspect ratio is displayed.

In addition, according to fourth aspect of the invention, the display device in accordance with the invention is characterized in that the substitute video signal is a portion of the inputted video signal.

Accordingly, masking with a substitute picture of the same picture quality as that of the picture portion can be realized unlike the conventional masking signal generated from the synchronizing signal and including jitter. Therefore, a disturbed portion of the picture is not produced in the vicinity of the boundary between the picture portion of the video signal and the blank portion on the display screen.

In addition, according to fifth aspect of the invention, the display device in accordance with the invention is characterized in that the substitute video signal is a predetermined pattern.

Accordingly, it is possible to realize masking by displaying visually stable substitute pictures on both sides of the picture.

In addition, as according to sixth aspect of the invention, the display device in accordance with the invention is characterized in that the predetermined pattern is that of a monochromatic black color.

Accordingly, substitute pictures which are visually stable, are not offensive to the eye, and allow the picture portion to contrast well can be displayed on both sides of the picture.

In addition, according to seventh aspect of the invention, the display device in accordance with the invention is characterized in that the predetermined substitute video signal overlaps the end portion of the picture portion of the inputted video signal by a portion of a predetermined length.

Accordingly, it is possible to completely mask the disturbed portion of the picture occurring in the vicinity of the boundary between the picture portion and each blank portion on the display screen.

In addition, according to eighth aspect of the invention, the display device in accordance with the invention is characterized in that the masking section generates the substitute video signal so that the width of the substitute picture displayed on the display screen changes with time.

Accordingly, it is possible to suppress the burning of the screen in the vicinity of the boundary between the picture portion and each blank portion on the display screen.

In addition, according to ninth aspect of the invention, a display method including a step of detecting a boundary position between a signal of a picture portion of a video signal whose aspect ratio differs and a signal of a non-picture portion on the basis of the video signal and a synchronizing signal, a step of generating a masking control signal for masking the non-picture portion and an end portion of the picture portion on the basis of the boundary position detected, and replacing the signals of the non-picture portion and the end of the picture portion with a predetermined substitute video signal on the basis of the masking control signal.

### BRIEF DESCRIPTION OF THE DRAWINGS

These and other objects and advantages of this invention will become more fully apparent from the following detailed description taken with the accompanying drawings in which:

FIG. 1 is an explanatory diagram illustrating a display screen of a display device in accordance with the invention;

FIG. 2 is a diagram illustrating the basic principle of the method of effecting a changeover of the display screen between a 4:3 aspect ratio and a 16:9 aspect ratio in the display device in accordance with the invention;

FIG. 3 is a block diagram illustrating the configuration of essential portions of the display device in accordance with an embodiment of the invention;

FIG. 4 is a timing chart illustrating the transition with time of the signal related to the display device in accordance with the embodiment of the invention;

FIG. 5 is an explanatory diagram illustrating an example of substitute picture portions of the display device in accordance with the embodiment of the invention;

FIG. 6 is an explanatory diagram illustrating another example of the substitute picture portions of the display device in accordance with the embodiment of the invention; and

FIG. 7 is an explanatory diagram explaining the disturbance of a picture which occurs in a case where the video signal having the 4:3 aspect ratio is displayed in a conventional display device having the display screen whose aspect ratio is 16:9.

### DETAILED DESCRIPTION OF THE PREFERRED EMBODIMENTS

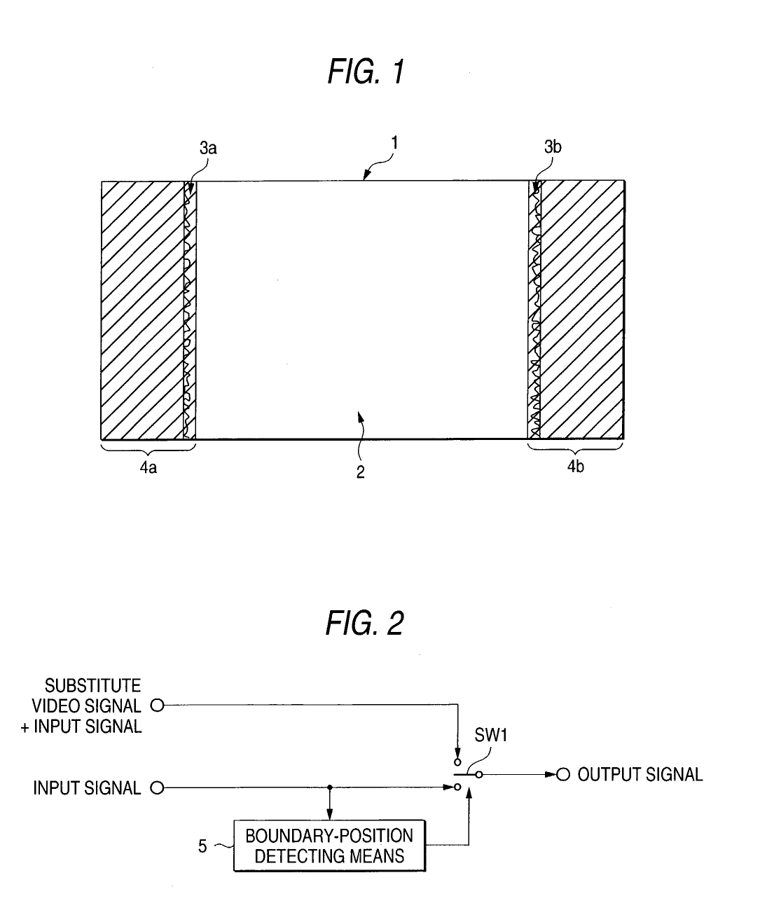

First, a description will be given of the basic principle of a display device in accordance with the invention. FIG. 1 is an explanatory diagram illustrating a display screen of the display device in accordance with the invention.

FIG. 1 shows that in a case where a video signal having an aspect ratio of 4:3 is displayed on a display screen 1 whose aspect ratio is 16:9, a picture portion 2 having the aspect ratio of 4:3 and substitute picture portions 4a and 4b are simultaneously displayed.

The width of each of these substitute picture portions 4a and 4b is set to a length in which the width of a portion of the picture portion 2 having the aspect ratio of 4:3 is added to the width of a blank portion (signal of a non-picture portion) in a conventional display device. Accordingly, disturbed portions 3a and 3b of the picture which occur at both end portions of the 4:3 picture portion 2 are completely masked by these substitute picture portions 4a and 4b.

Unlike a masking signal for generating a blank portion of a black color or the like in the conventional display device, a signal for generating each of these substitute picture portions 4a and 4b employs a predetermined pattern (e.g., a monochromatic black color) generated by a substitute video signal generator installed inside the device, or employs a portion of the video signal after its luminance is adjusted.

In addition, the width of each of these substitute picture portions 4a and 4b is made variable, and by causing them to change with time, the burning of the screen which occurs in the vicinity of a boundary between each of the substitute picture portions 4a and 4b and the picture is suppressed.

FIG. 2 shows the basic principle of the method of effecting a changeover of the display screen between the 4:3 aspect ratio and the 16:9 aspect ratio in the display device in accordance with the invention.

A boundary-position detector 5 constantly monitors input signals. Upon detecting a boundary position between a video signal which is a portion peculiar to the video signal having the 4:3 aspect ratio and a signal of the blank portion (non-picture portion), the boundary-position detector 5 transmits a signal representing this detection to a switch SW1. Consequently, the switch SW1 changes over the output signal to the side of a substitute video signal+input signal.

In addition, in a case where the boundary position between the video signal which is a portion peculiar to the video signal having the 4:3 aspect ratio and the signal of the blank portion (non-picture portion) is not detected, the boundary-position detector 5 transmits a signal representing this non-detection to the switch SW1. Consequently, the switch SW1 changes over the output signal to the side of an input signal.

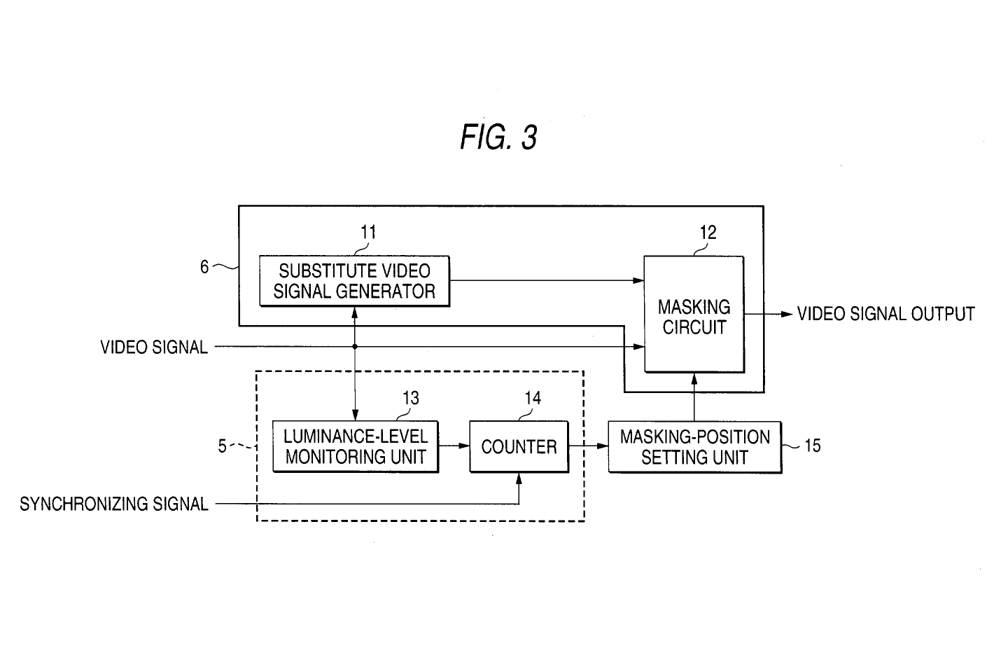

Hereafter, a description will be given of the display device in accordance with an embodiment of the invention with reference to the drawings. FIG. 3 is a block diagram illustrating the configuration of essential portions of the display device in accordance with the embodiment of the invention.

The display device shown in FIG. 3 is comprised of a substitute video signal generator 11 (one of a masking section 6) for generating a substitute video signal having a predetermined pattern or extracted from a portion of the video signal, a masking circuit 12 (one of the masking section 6) including a function for masking the portion of the video signal with the substitute video signal, a luminance-level monitoring unit 13 (one of the boundary-position detector 5) for monitoring the luminance level of the video signal, a counter 14 (one of the boundary-position detector 5) for detecting the position within the picture to be masked on the basis of the signal from the luminance-level monitoring unit 13, and a masking-position setting unit 15 (masking-control-signal generator) for generating a masking control signal on the basis of information on the masking position from the counter 14.

Hereafter, a description will be given of the operation of the display device in accordance with this embodiment.

The substitute video signal generator 11 generates a substitute video signal which is formed by a predetermined pattern or a portion of the video signal.

By using an unillustrated element, a user is able to designate which signal of the aforementioned pattern or the portion of the video signal is to be generated.

The noteworthy point here is that in the case where the portion (a signal corresponding to a predetermined partial region) of the video signal is extracted, the portion is extracted from the video signal per se, and is not formed on the basis of a synchronizing signal of the video signal in the conventional manner.

In addition, the width of this substitute video signal on the display screen is constantly made to overlap an adjacent picture portion by a predetermined slight length by exceeding the blank portion (non-picture portion).

Further, the width of this substitute video signal on the display screen can be made variable (accordingly, in this case, the aforementioned predetermined slight length is defined as a variable length). By causing this width to change with time, the burning of the screen is suppressed in the vicinity of the boundary between each of the substitute picture portions 4a and 4b and the picture portion 2 having the 4:3 aspect ratio, which are shown in FIG. 1.

On the basis of the masking control signal from the masking-position setting unit 15 which will be described later, the masking circuit 12 selectively outputs as a video signal output either one of the video signal as it is and the video signal formed by masking the portion of the video signal with the substitute video signal.

In a case where the masking control signal is being transmitted from the masking-position setting unit 15, the signal in which the portion of the video signal is masked with the substitute video signal is outputted as the video signal on the basis of this masking control signal.

In addition, in a case where the masking control signal is not being transmitted from the masking-position setting unit 15, the inputted video signal is outputted as it is as the video signal.

A video signal is inputted to the luminance-level monitoring unit 13 to monitor its luminance level. As a method of monitoring this luminance level, in a case where the blank portion (non-picture portion) is set to be black, for example, a section where the detected luminance level of the video signal is lower than a predetermined threshold can be determined to be the blank portion in the video signal having the 4:3 aspect ratio.

The counter 14 includes a counter which is reset by the horizontal synchronizing signal, and detects the position (timing) within the picture to be masked with respect to the video signal having the 4:3 aspect ratio on the basis of the count value indicated by this counter and the signal from the luminance-level monitoring unit 13.

More specifically, on the basis of the count value indicated by the counter and the signal from the luminance-level monitoring unit 13, the counter 14 detects a first position (boundary position between the blank portion and the picture display portion on the left side of the screen) where the luminance level changes from a level less than the aforementioned threshold to a level equal to or greater than the aforementioned threshold and a second position (boundary position between the picture display portion and the blank portion on the right side of the screen) where the luminance level changes from a level equal to or greater than the aforementioned threshold to a level less than the aforementioned threshold.

The masking-position setting unit 15 generates the masking control signal on the basis of the information on the masking position from the counter 14. More specifically, the masking-position setting unit 15 generates the masking control signal for masking the left and right sides of the screen on the basis of the information on the aforementioned first and second positions.

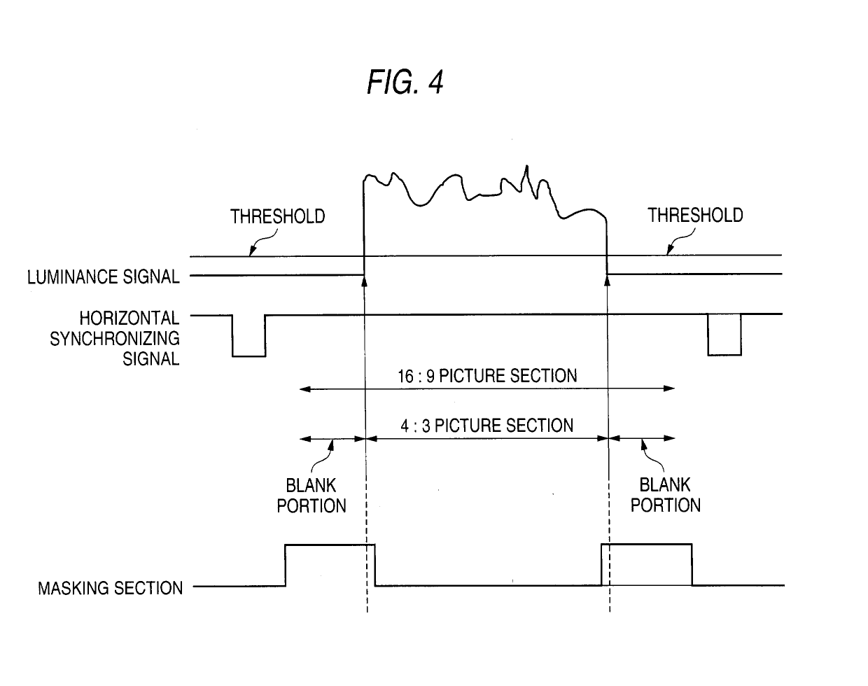

FIG. 4 is a timing chart showing the transition with time of the signal related to the display device in accordance with the embodiment of the invention.

In FIG. 4, the case of the video signal having the 4:3 aspect ratio is principally shown. Accordingly, in the case of the video signal having the 16:9 aspect ratio, the luminance level of the luminance signal is equal to or greater than the threshold at the starting timing of the blank portion, and the masking section based on the masking signal is not present.

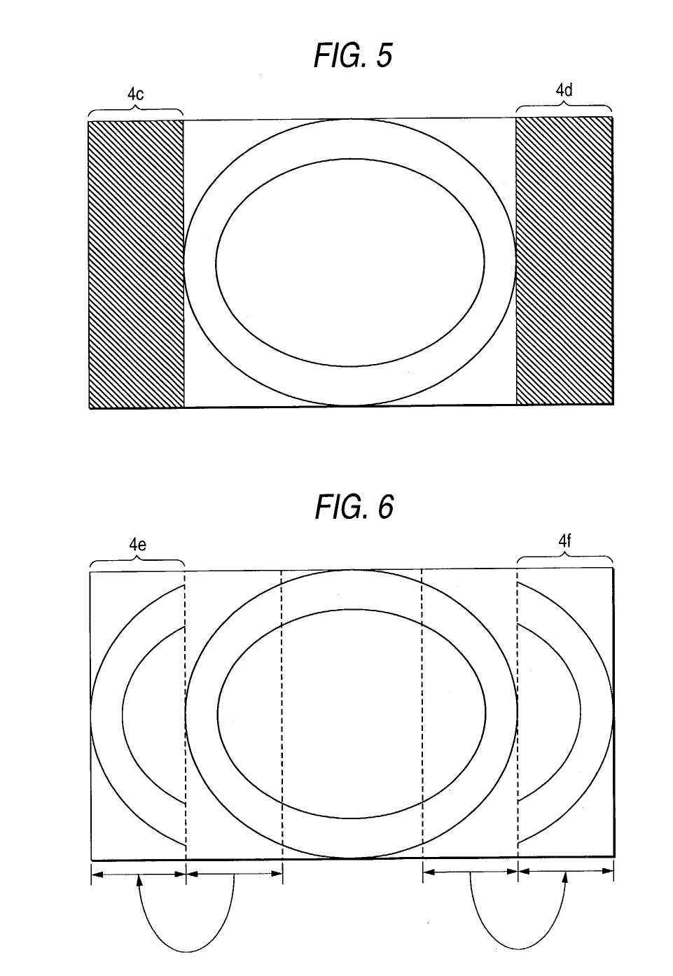

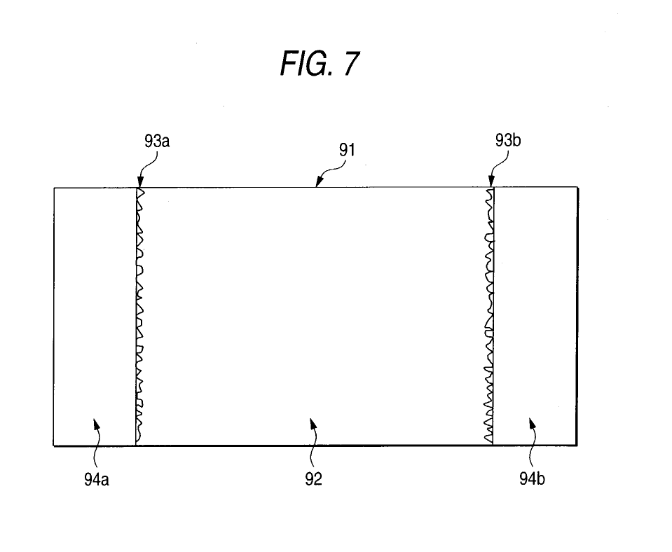

FIG. 5 is an explanatory diagram illustrating an example of the substitute picture portions of the display device in accordance with the embodiment of the invention.

Substitute picture portions 4c and 4d are masked with a predetermined pattern generated by the substitute video signal generator 11 (in FIG. 5, they are masked with a pattern of a monochromatic black color).

FIG. 6 is an explanatory diagram illustrating another example of the substitute picture portions of the display device in accordance with the embodiment of the invention.

Substitute picture portions 4e and 4f are masked with portions of the video signal extracted by the substitute video signal generator 11 (in FIG. 6, they are masked with substitute video signals abstracted from both end portions of the video signal).

As described above, in accordance with this embodiment, the disturbed portion of the picture in the vicinity of the boundary between the picture portion of the video signal having the 4:3 aspect ratio and the blank portion on the display screen can be completely masked with a predetermined pattern generated by the substitute video signal generator 11 or a portion of the video signal extracted by the substitute video signal generator 11.

In addition, by causing the width of each substitute picture portion to change with time, it is possible to suppress the burning of the display screen caused by the video signal having the 4:3 aspect ratio in the vicinity of the boundary between the picture portion and each blank portion.

As described above, in accordance with the invention according to first aspect of the invention, the display device which is capable of displaying either one of a video signal whose aspect ratio coincides with that of a display screen and a video signal whose aspect ratio differs includes a boundary-position detector for detecting a boundary position between a signal of a picture portion of the video signal whose aspect ratio differs and a signal of a non-picture portion on the basis of the video signal and a synchronizing signal which are inputted to the boundary-position detector, a masking-control-signal generator for generating a masking control signal for masking the non-picture portion and an end portion of the picture portion on the basis of the boundary position detected, and masking section for replacing the signals of the non-picture portion and the end of the picture portion with a predetermined substitute video signal on the basis of the masking control signal. Accordingly, it is possible to provide a display device in which, when the video signal whose aspect ratio differs from a predetermined aspect ratio is displayed, a disturbed portion of the picture is not produced in the vicinity of a boundary between the picture portion of the video signal and the blank portion on the display screen.

In addition, in accordance with the invention according to second aspect of the invention, since the boundary-position detector detects the boundary position by detecting a change of luminance of the inputted video signal, the detection of the boundary between the picture portion and the blank portion can be realized by a simple circuit configuration.

In addition, in accordance with the invention according to third aspect of the invention, the aspect ratio of the display screen is 16:9, and the aspect ratio of the video signal whose aspect ratio differs is 4:3. Therefore, in the display device having the display screen whose aspect ratio is 16:9, such as a high definition television, a disturbed portion of the picture is not produced in the vicinity of the boundary between the picture portion and the blank portion when the conventional video signal having the 4:3 aspect ratio is displayed.

In addition, in accordance with the invention according to fourth aspect of the invention, since the substitute video signal is a portion of the inputted video signal, masking with a substitute picture of the same picture quality as that of the picture portion can be realized unlike the conventional masking signal generated from the synchronizing signal and including jitter. Therefore, a disturbed portion of the picture is not produced in the vicinity of the boundary between the picture portion of the video signal and the blank portion on the display screen.

In addition, in accordance with the invention according to fifth aspect of the invention, since the substitute video signal is a predetermined pattern, it is possible to display visually stable masks on both sides of the picture.

In addition, in accordance with the invention according to sixth aspect of the invention, since the predetermined pattern is that of a monochromatic black color, masks which are visually stable, are not offensive to the eye, and allow the picture portion to contrast well can be displayed on both sides of the picture.

In addition, in accordance with the invention according to seventh aspect of the invention, the predetermined substitute video signal overlaps the end portion of the picture portion of the inputted video signal by a portion of a predetermined length. Therefore, it is possible to completely mask the disturbed portion of the picture occurring in the vicinity of the boundary between the picture portion and each blank portion on the display screen.

In addition, in accordance with the invention according to eighth aspect of the invention, the masking section generates the substitute video signal so that the width of the substitute picture displayed on the display screen changes with time. Therefore, it is possible to suppress the burning of the screen in the vicinity of the boundary between the picture portion and each blank portion on the display screen.

What is claimed is:

1. A display device that is capable of displaying either one of a video signal whose aspect ratio coincides with that of a display screen and a video signal whose aspect ratio differs comprising:
a boundary-position detector for detecting a boundary position between a signal of a picture portion of the video signal whose aspect ratio differs and a signal of a non-picture portion on the basis of the video signal and a synchronizing signal which are inputted to the boundary-position detector;
a masking-control-signal generator for generating a masking control signal for masking the non-picture portion and an end portion of the picture portion on the basis of the boundary position detected; and
a masking section for replacing the signals of the non-picture portion and the end of the picture portion with a predetermined substitute video signal on the basis of the masking control signal.

2. The display device according to claim 1, wherein the boundary-position detector detects the boundary position by detecting a change of luminance of the inputted video signal.

3. The display device according to claim 1, wherein the aspect ratio of the display screen is 16:9, and the aspect ratio of the video signal whose aspect ratio differs is 4:3.

4. The display device according to claim 1, wherein the substitute video signal is a portion of the inputted video signal.

5. The display device according to claim 1, wherein the substitute video signal is a predetermined pattern.

6. The display device according to claim 5, wherein the predetermined pattern is a monochromatic black color.

7. The display device according to claim 1, wherein the predetermined substitute video signal overlaps the end portion of the picture portion of the inputted video signal by a portion of a predetermined length.

8. The display device according to claim 1, wherein the masking section generates the substitute video signal so that the width of the substitute picture displayed on the display screen changes with time.

9. A display method comprising the steps of:
detecting a boundary position between a signal of a picture portion of a video signal whose aspect ratio differs and a signal of a non-picture portion on the basis of the video signal and a synchronizing signal;
generating a masking control signal for masking the non-picture portion and an end portion of the picture portion on the basis of the boundary position detected; and
replacing the signals of the non-picture portion and the end of the picture portion with a predetermined substitute video signal on the basis of the masking control signal.
